(19) United States
(12) Patent Application Publication
(10) Pub. No.: US 2021/0064101 A1
(43) Pub. Date: Mar. 4, 2021

(54) FIXING STRUCTURE

(71) Applicants: Inventec (Pudong) Technology Corporation, Shanghai City (CN); INVENTEC CORPORATION, Taipei City (TW)

(72) Inventors: SHU-MIN WANG, Shanghai City (CN); Jia-Bin WANG, Shanghai City (CN)

(21) Appl. No.: 16/566,266

(22) Filed: Sep. 10, 2019

(30) Foreign Application Priority Data
Aug. 30, 2019 (CN) 201910815620.3

(51) Int. Cl. G06F 1/18

(52) U.S. Cl. CPC G06F 1/185; G06F 1/184; G06F 1/186

(57) ABSTRACT

A fixing structure configured to fix an expansion card to a motherboard and including a support plate and a holder. The support plate has a top side, a bottom side and a first side surface. The top side is located opposite to the bottom side. The first side surface is located between the top side and the bottom side. The first side surface is configured to hold the expansion card. The bottom side is configured to be fixed to the motherboard. The holder includes a connecting part and a fixing part that are located opposite to each other. The connecting part is connected to the top side of the support plate. The fixing part is configured to be fixed to the motherboard.

### CROSS-REFERENCE TO RELATED APPLICATIONS

This non-provisional application claims priority under 35 U.S.C. § 119(a) on Patent Application No(s). 201910815620.3 filed in China, on Aug. 30, 2019, the entire contents of which are hereby incorporated by reference.

### BACKGROUND OF THE INVENTION

### Technical Field of the Invention

The invention relates to a fixing structure, more particularly to a fixing structure configured to fix an expansion card to a motherboard.

### Description of the Related Art

In general, a bottom side of an expansion card is plugged into the socket of a motherboard, and a top side of the expansion card is fixed to a side wall of a server chassis via a fixing structure, such that the expansion card can be plugged into the socket of the motherboard in a stable manner.

### SUMMARY OF THE INVENTION

One embodiment of this invention provides a fixing structure configured to fix an expansion card to a motherboard and including a support plate and a holder. The support plate has a top side, a bottom side and a first side surface. The top side is located opposite to the bottom side. The first side surface is located between the top side and the bottom side. The first side surface is configured to hold the expansion card. The bottom side is configured to be fixed to the motherboard. The holder includes a connecting part and a fixing part that are located opposite to each other. The connecting part is connected to the top side of the support plate. The fixing part is configured to be fixed to the motherboard.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a partially enlarged perspective view of a fixing structure according to one embodiment of the invention, a side wall, a motherboard and an expander board;

FIG. 2 is a perspective view of the fixing structure in FIG. 1;

FIG. 3 is an exploded view of the fixing structure in FIG. 2;

FIG. 4 is a front view of the fixing structure in FIG. 2; and

FIG. 5 is another partially enlarged perspective view of the fixing structure, the side wall, the motherboard and the expander board in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

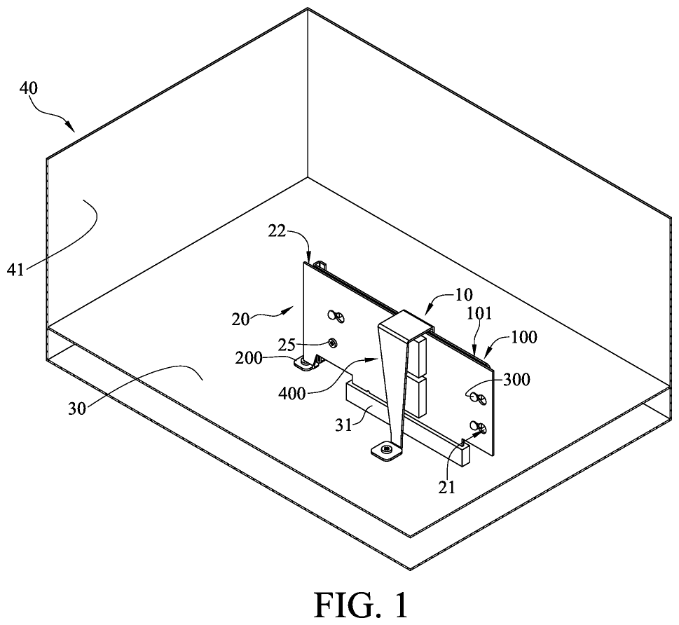

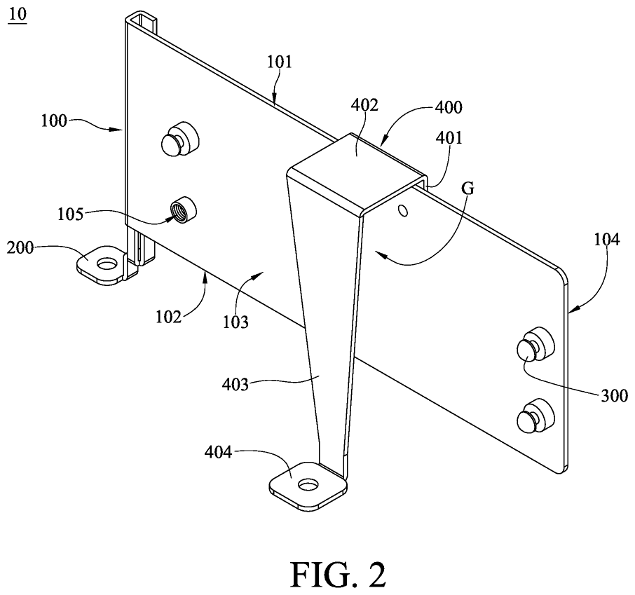

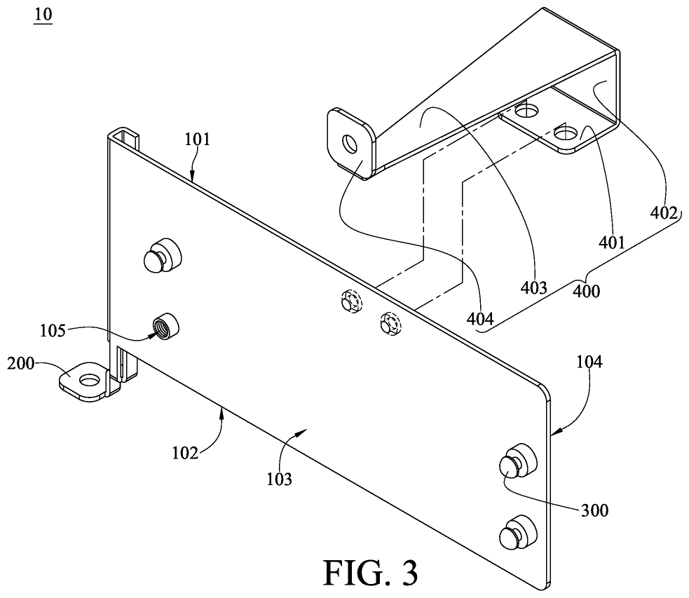

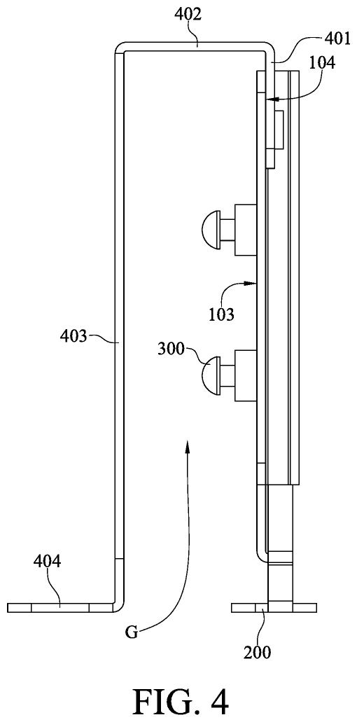

Please refer to FIG. 1 to FIG. 4, where FIG. 1 is a partially enlarged perspective view of a fixing structure 10 according to one embodiment of the invention, FIG. 1 also shows a side wall 41, a motherboard 30 and an expander board 20, FIG. 2 is a perspective view of the fixing structure 10 in FIG. 1, FIG. 3 is an exploded view of the fixing structure 10 in FIG. 2, and FIG. 4 is a front view of the fixing structure 10 in FIG. 2.

In this embodiment, the fixing structure 10 is configured to secure the position of the expansion card 20 mounted on the motherboard 30. The fixing structure 10 includes a support plate 100, a fixing component 200, a plurality of pillars 300 and a holder 400.

In this embodiment, the support plate 100 has a top side 101, a bottom side 102, a first side surface 103, a second side surface 104 and a screw hole 105. The top side 101 is located opposite to the bottom side 102. That is, the top side 101 and bottom side 102 are opposite sides of the support plate 100. The first side surface 103 and the second side surface 104 are located between the top side 101 and the bottom side 102 and are opposite surfaces of the support plate 100. The screw hole 105 is located on the first side surface 103.

However, the support plate 100 is not limited to have the screw hole 105; in other embodiments, the support plate may not have the screw hole 105.

The fixing component 200 is disposed on the bottom side 102 of the support plate 100, and is configured to be fixed on the motherboard 30.

However, the fixing component 200 is not limited to be disposed on the bottom side 102 of the support plate 100; in other embodiments, the fixing component may be disposed on the second side surface and extends toward the bottom side of the support plate so as to be configured to be fixed to the motherboard.

The pillars 300 protrude from the first side surface 103 of the support plate 100 and are respectively configured to be engaged with a plurality of holes 21 of the expansion card 20.

However, the fixing structure 10 is not limited to include the pillars 300; in other embodiments, the fixing structure may not include the pillar; in this case, the expansion card may or may not have the holes and can be adhered to the support plate of the fixing structure.

In this embodiment, the holder 400 includes a mount part 401, a connecting part 402, an extension part 403 and a fixing part 404. In this embodiment, the mount part 401 is fixed to the second side surface 104 of the support plate 100 and is connected to the top side 101 of the support plate 100. Two opposite sides of the connecting part 402 are respectively connected to the mount part 401 and the extension part 403, such that the extension part 403 is spaced apart from the first side surface 103 of the support plate 100 by a gap G. The gap G between the extension part 403 and the extension part 403 allows air to flow therethrough to take away heat generated by the electronic components (not labeled) on the expansion card 20. In addition, in this embodiment, the first side surface 103 is located between the mount part 401 and the extension part 403, and that is to say that the mount part 401 and the extension part 403 are respectively located on two opposite sides of the support plate 100. Furthermore, in this embodiment, the connecting part 402 is, for example, perpendicular to the support plate 100, and the extension part 403 is, for example, parallel to the support plate 100. The fixing part 404 is connected to a side of the extension part 403 that is located away from the connecting part 402, and is configured to be fixed on the motherboard 30. Moreover, in this embodiment, the extension part 403 is, for example, tapered from a side of the extension part 403 that is connected to the connecting part 402 to another side of the extension part 403 that is connected to the fixing part 404. By the cooperation of the mount part 401, the connecting part 402, the extension part 403 and the fixing part 404, the holder 400 can fix the top side 101 of the support plate 100 in position.

However, the mount part 401 is not limited to be fixed to the second side surface 104; in other embodiments, the mount part may be fixed to a part of the first side surface that is not covered by the expansion card and is located adjacent to the top side.

Additionally, the connecting part 402 is not limited to be perpendicular to the support plate 100; in other embodiments, the connecting part may have an acute angle to the support plate.

Moreover, the extension part 403 is not limited to be parallel to the support plate 100; in other embodiments, the extension part may have an acute angle at the support plate.

Furthermore, the invention is not limited by the position relationship between the first side surface 103, the mount part 401 and the extension part 403; in other embodiments, the mount part may be located between the first side surface and the extension part, and that is to say that the mount part and the extension part may be located on the same side of the support plate.

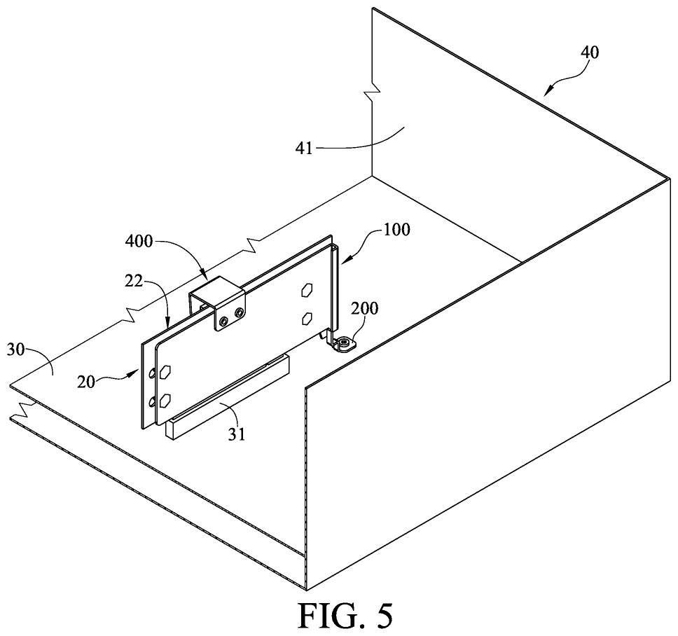

Please refer to FIG. 1 and FIG. 5, where FIG. 5 is another partially enlarged perspective view of the fixing structure, the side wall, the motherboard and the expander board in FIG. 1. Firstly, the connection between the expansion card 20 and the support plate 100 is described herein. Referring to FIG. 1, the expansion card 20 can be fixed to the first side surface 103 of the support plate 100 by respectively engaging the pillars 300 with the holes 21 of the expansion card 20, and then a screw 25 can be screwed through the expansion card 20 and into the screw hole 105 to secure the position of the expansion card 20 on the support plate 100.

Then, the way to install the expansion card 20 to the motherboard 30 by using the support plate 100 is described herein. Referring to FIG. 1 and FIG. 5, the motherboard 30 can be disposed on, for example, a server chassis 40, the motherboard 30 has a socket 31 located relatively away from the side wall 41 of the sever chassis 40. The expansion card 20 can be plugged into the socket 31 of the motherboard 30, and the fixing component 200 can be screwed onto the motherboard 30. By doing so, the bottom side 102 of the support plate 100 is fixed in position relative to the motherboard 30 by the fixing component 200. The fixing part 404 of the holder 400 also can be screwed to the motherboard 30. As such, the top side 101 of the support plate 100 is fixed in position relative to the motherboard 30 as well. In such a case, the expansion card 20 that is fixed on the first side surface 103 of the support plate 100 is fixed in position relative to the motherboard 30 without having any direct structural connection from the side wall 41.

According to the fixing structure discussed above, the connecting part of the holder is connected to the top side of the support plate, the fixing part of the holder connected to the connecting part is fixed to the motherboard, and the expansion card is disposed on the first side surface of the support plate. Therefore, for the expansion card that is plugged into the socket located relatively away from the side wall, the holder can position the top side of the support plate only by being fixed to the motherboard, thereby allowing the expansion card to be fixed in positon relative to the motherboard.

It will be apparent to those skilled in the art that various modifications and variations can be made to the present invention. It is intended that the specification and examples be considered as exemplary embodiments only, with a scope of the invention being indicated by the following claims and their equivalents.

What is claimed is:

1. A fixing structure, configured to fix an expansion card to a motherboard, the fixing structure comprising:
a support plate, having a top side, a bottom side and a first side surface, wherein the top side is located opposite to the bottom side, the first side surface is located between the top side and the bottom side, the first side surface is configured to hold the expansion card, and the bottom side is configured to be fixed to the motherboard; and
a holder, comprising a connecting part and a fixing part that are located opposite to each other, the connecting part connected to the top side of the support plate, wherein the fixing part is configured to be fixed to the motherboard.

2. The fixing structure according to claim 1, wherein the holder further comprises a mount part and an extension part, the mount part is fixed to the support plate, two opposite sides of the connecting part are respectively connected to the mount part and the extension part so that the extension part is spaced apart from the first side surface of the support plate by a gap, and the fixing part is connected to a side of the extension part that is located away from the connecting part.

3. The fixing structure according to claim 2, wherein the connecting part is perpendicular to the support plate.

4. The fixing structure according to claim 2, wherein the extension part is parallel to the support plate.

5. The fixing structure according to claim 2, wherein the mount part of the holder is fixed to a second side surface of the support plate that faces away from the first side surface.

6. The fixing structure according to claim 5, wherein the first side surface is located between the mount part and the extension part.

7. The fixing structure according to claim 2, wherein the extension part is tapered from a side of the extension that is connected to the connecting part to another side of the extension that is connected to the fixing part.

8. The fixing structure according to claim 1, further comprising a fixing component, the fixing component disposed on the bottom side of the support plate and configured to be fixed to the motherboard.

9. The fixing structure according to claim 1, further comprising at least one pillar protruding from the first side surface of the support plate.

10. The fixing structure according to claim 1, wherein the support plate further has a screw hole located on the first side surface of the support plate.
